(19) United States
(12) Patent Application Publication
(10) Pub. No.: US 2005/0024275 A1
(43) Pub. Date: Feb. 3, 2005

(54) Method and apparatus for reducing SAR exposure in a communications handset device

(76) Inventors: Young-Min Jo, Rockledge, FL (US); Se-hyun Oh, Seoul (KR); Joo-Mun Lee, Gyeonggi-do (KR); Jin-Hee Yoon, Seoul (KR); Sang-Ok Choi, Seoul (KR); Ki-Hak Shim, Gyeonggi-do (KR); Eun-Seok Han, Seoul (KR)

Correspondence Address: BEUSSE BROWNLEE WOLTER MORA & MAIRE, P. A., 390 NORTH ORANGE AVENUE, SUITE 2500, ORLANDO, FL, 32801, US

(21) Appl. No.: 10/873,909

(22) Filed: Jun. 22, 2004

Related U.S. Application Data
(60) Provisional application No. 60/484,035, filed on Jul. 1, 2003.

(51) Int. Cl. H01Q 1/24

(52) U.S. Cl. 343/702

(57) ABSTRACT

An antenna structure for use in a communications device for reducing a user's SAR exposure. In addition to the conventional antenna elements, e.g., a radiating element and a ground plane, the antenna structure of the present invention comprises a conductive element for directing radio frequency energy emitted by the radiating element away from the user, thereby reducing the user's SAR exposure. The conductive element can be disposed on an interior or an exterior surface of a case enclosing the communications device.

The present application claims the benefit of the provisional patent application filed on Jul. 1, 2003 and assigned application No. 60/484,035.

### FIELD OF THE INVENTION

The present invention relates to antennas generally, and specifically to techniques for reducing a SAR (specific absorption ratio) exposure experienced by a user when operating a handheld communications device employing an antenna for emitting radio frequency energy.

### BACKGROUND OF THE INVENTION

It is generally known that antenna performance is dependent upon the size, shape and material composition of the constituent antenna elements, as well as the relationship between certain antenna physical parameters (e.g., length for a linear antenna and diameter for a loop antenna) and the wavelength of the signal received or transmitted by the antenna. These relationships determine several antenna operational parameters, including input impedance, gain, directivity, signal polarization, operating frequency, bandwidth and radiation pattern. Generally for an operable antenna, the minimum physical antenna dimension (or the electrically effective minimum dimension) must be on the order of a quarter wavelength (or a multiple thereof) of the operating frequency, which thereby advantageously limits the energy dissipated in resistive losses and maximizes the transmitted energy. Half wavelength antennas and quarter wavelength antennas over a ground plane are the most commonly used.

The burgeoning growth of wireless communications devices and systems has created a substantial need for physically smaller, less obtrusive, and more efficient antennas that are capable of wide bandwidth or multiple frequency-band operation, and/or operation in multiple modes (i.e., selectable radiation patterns or selectable signal polarizations). Smaller package or case envelopes of these state-of-the-art communications devices, such as cellular telephone handsets and other portable devices, do not provide sufficient space for the conventional quarter and half wavelength antenna elements. Thus physically smaller antennas operating in the frequency bands of interest, and providing other desired antenna-operating properties (input impedance, radiation pattern, signal polarizations, etc.) are especially sought after.

Half wavelength and quarter wavelength dipole antennas are popular externally mounted handset antennas. Both antennas exhibit an omnidirectional radiation pattern (i.e., the familiar omnidirectional donut shape) with most of the energy radiated uniformly in the azimuth direction and little radiation in the elevation direction. Frequency bands of interest for certain communications devices are 1710 to 1990 MHz and 2110 to 2200 MHz. A half-wavelength dipole antenna is approximately 3.11 inches long at 1900 MHz, 3.45 inches long at 1710 MHz, and 2.68 inches long at 2200 MHz. The typical antenna gain is about 2.15 dBi. Antennas of this length may not be suitable for most handset applications.

The quarter-wavelength monopole antenna disposed above a ground plane is derived from a half-wavelength dipole. The physical antenna length is a quarter-wavelength, but when placed above a ground plane the antenna performs as half-wavelength dipole. Thus, the radiation pattern for a monopole antenna above a ground plane is similar to the half-wavelength dipole pattern, with a typical gain of approximately 2 dBi.

Several different antenna types known in the art can be embedded within a communications handset device. Generally, it is desired that these antennas exhibit a low profile so as to fit within the available space envelope of the handset package. Antennas protruding from the handset case are prone to damage by breaking or bending.

A loop antenna is one example of an antenna that can be embedded in a handset. The common free space (i.e., not above ground plane) loop antenna (with a diameter approximately one-third of the signal wavelength) displays the familiar donut radiation pattern along the radial axis, with a gain of approximately 3.1 dBi. At 1900 MHz, this antenna has a diameter of about 2 inches. The typical loop antenna input impedance is 50 ohms, providing good matching characteristics.

Antenna structures comprising planar radiating and/or feed elements can also be employed as embedded antennas. One such antenna is a hula-hoop antenna, also known as a transmission line antenna (i.e., comprising a conductive element over a ground plane). The loop is essentially inductive and therefore the antenna includes a capacitor connected between a ground plane and one end of the hula-hoop conductor to create a resonant structure. The other end serves as the feed point for a received or transmitted signal.

Printed or microstrip antennas are constructed using patterning and etching techniques employed in the fabrication of printed circuit boards. These antennas are popular because of their low profile, the ease with which they can be formed and their relatively low fabrication cost. Typically, a patterned metallization layer on a dielectric substrate operates as the radiating element. A patch antenna, one example of a printed antenna, comprises a dielectric substrate overlying a ground plane, with the radiating element overlying a top surface of the substrate. The patch antenna provides directional hemispherical coverage with a gain of approximately 3 dBi.

Another type of printed or microstrip antenna comprises a spiral or a sinuous antenna having a conductive element in a desired shape formed on one face of a dielectric substrate with a ground plane disposed on an opposing face.

Another example of an antenna suitable for embedding in a handset device is a dual loop or dual spiral antenna described and claimed in the commonly owned application entitled Dual Band Spiral-shaped Antenna, filed on Oct. 31, 2002 and assigned application Ser. No. 10/285,291. The antenna offers multiple frequency band and/or wide bandwidth operation, exhibits a relatively high radiation efficiency and gain, along with a low profile and low fabrication cost.

As shown in FIG. 1, a spiral antenna 8 comprises a radiator 10 over a ground plane 12. The ground plane 12 comprises an upper and a lower conductive material surface separated by a dielectric substrate, or in another embodiment comprises a single sheet of conductive material disposed on a dielectric substrate. The radiator 10 is disposed substantially parallel to and spaced apart from the ground plane 12, with a dielectric gap 13 (comprising, for example, air or other known dielectric materials) therebetween. In one embodiment the distance between the ground plane 12 and radiator 10 is about 5 mm. An antenna constructed according to FIG. 1 is suitably sized for insertion in a typical handset communications device.

A feed pin 14 and a ground pin 15 are also illustrated in FIG. 1. One end of the feed pin 14 is electrically connected to the radiator 10. An opposing end is electrically connected to a feed trace 18 extending to an edge 20 of the ground plane 12. A connector (not shown in FIG. 1), is connected to the feed trace 18 for providing a signal to the antenna 8 in the transmitting mode and responsive to a signal from the antenna 8 in the receiving mode. As is known, the feed trace 18 is insulated from the conductive surface of the ground plane 12. The feed trace 18 is formed from the conductive material of the ground plane 12 by removing a region of the conductive material surrounding the feed trace 18, thus insulating the feed trace 18 from the ground plane 12.

As illustrated in the detailed view of FIG. 2, the radiator 10 comprises two coupled and continuous loop conductors (also referred to as spirals or spiral segments) 24 and 26 disposed on a dielectric substrate 28. The outer loop 24 is the primary radiating region and exercises primary influence over the antenna resonant frequency. The inner loop 26 primarily affects the antenna gain and operational bandwidth. However, it is known that there is significant electrical interaction between the outer loop 24 and the inner loop 26. Thus it may be a technical oversimplification to indicate that one or the other is primarily responsible for determining an antenna parameter, as the interrelationship can be complex. Also, although the radiator 10 is described as comprising an outer loop 24 and an inner loop 26, there is not an absolute line of demarcation between these two elements.

Another spiral antenna 40 illustrated in FIG. 3 operates in the cellular and personal communication service (PCS) bands of 824-894 MHz and 1850-1990 MHz, respectively and is also suitable for use as an embedded antenna for a handset communications device. The antenna 40 is constructed from a sheet of relatively thin conductive material (copper, for example) and comprises a radiator 42 having a generally spiral shape. The spiral shape can be considered as comprising an inner spiral segment (or loop) 44 and an outer spiral segment (or loop) 46, although it is known that there is no physical line of demarcation between the inner and outer spiral segments 44 and 46, rather these references relate generally to approximate regions of the radiator 42. A feed pin 50 and a ground or shorting pin 52 extends downwardly from a plane of the radiator 42.

When installed in a communications device, the antenna 40 is typically mounted to a printed circuit board. A signal is fed to or received from the feed pin 50 from a feed trace on the printed circuit board. The shorting pin 52 connects to a ground plane of the printed circuit board. Electrical components can also be mounted on the printed circuit board for operation with the antenna 40 to provide the transmitting and receiving functions of the communications device. The antenna 40 comprises a compact spiral shaped radiator providing desired operating characteristics in a volume suitable for installation in handsets and other applications where space is at a premium.

There is some concern among handset users and manufactures regarding the effects of the radio frequency energy emitted by a cellular telephone handset when held proximate the user's ear during use, such as during a telephone conversation. In particular, the radio frequency energy may cause brain cell heating, and prolonged and frequent use may therefore promote detrimental health effects. A specific absorption ratio (SAR) is one measure of the amount of radiation absorbed by the user's body when the handset device is transmitting. A cellular telephone's maximum SAR level must be less than 1.6 watts/kilogram.

### BRIEF SUMMARY OF THE INVENTION

The invention comprises a communications device operative in proximate relation to a user to transmit and receive radio frequency signals. The device comprises a radio frequency signal radiating element and a ground plane spaced apart from and operative in conjunction with the radiating element. A conductive element disposed proximate the radiating element reduces the energy emitted in a direction toward the user.

### BRIEF DESCRIPTION OF THE DRAWINGS

The foregoing and other features of the invention will be apparent from the following more particular description of the invention, as illustrated in the accompanying drawings, in which like reference characters refer to the same parts throughout the different figures. The drawings are not necessarily to scale, emphasis instead being placed upon illustrating the principles of the invention.

FIGS. 1-3 are perspective views of various antennas having a relatively thin configuration;

FIG. 4 illustrates a prior art handset device in position proximate the head of a user during use;

FIG. 5 illustrates an interior view of an exemplary handset device such as the handset device of FIG. 4;

FIGS. 6 and 7 illustrate exemplary radiation patterns of the handset device of FIG. 4;

FIG. 8 illustrates a cross-sectional view of a SAR-reducing device of the present invention;

FIG. 9 illustrates the radiation pattern of a handset device employing the SAR-reducing device of FIG. 8; and

FIGS. 10-12 illustrate other embodiments according to the teachings of the present invention.

### DETAILED DESCRIPTION OF THE INVENTION

Before describing in detail the particular antenna apparatus of the present invention, it should be observed that the present invention resides primarily in a novel and non-obvious combination of elements. Accordingly, the inventive elements have been represented by conventional elements in the drawings, showing only those specific details that are pertinent to the present invention so as not to obscure the disclosure with structural details that will be readily apparent to those skilled in the art having the benefit of the description herein.

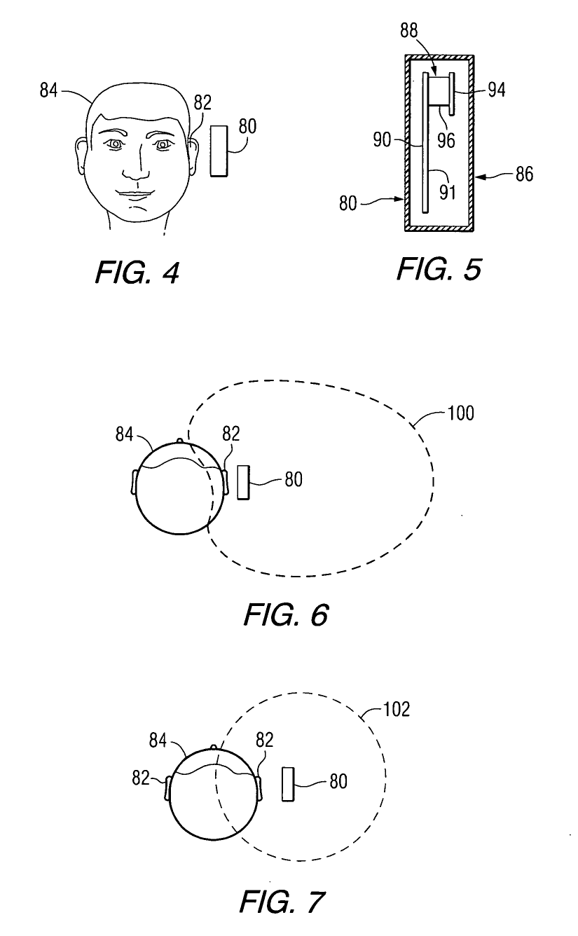

FIG. 4 illustrates a conventional handset 80 for receiving and/or transmitting radio frequency energy, such as a cellular telephone, in an operational position where the handset 80 is positioned next to an ear 82 of a user 84. The handset 80 is further illustrated in FIG. 5, comprising a handset case 86 enclosing an embedded antenna 88 that is physically and electrically attached to a printed circuit board 90 carrying a ground plane 91. Conventionally the ground plane 91 comprises a conductive region disposed on a portion of the printed circuit board 90, with electronic components and interconnecting conductive traces (not shown in FIG. 5) occupying the remainder of the printed circuit board 90. The ground plane 91 interacts with the antenna 88 to produce desired transmitting and receiving properties for the antenna 88.

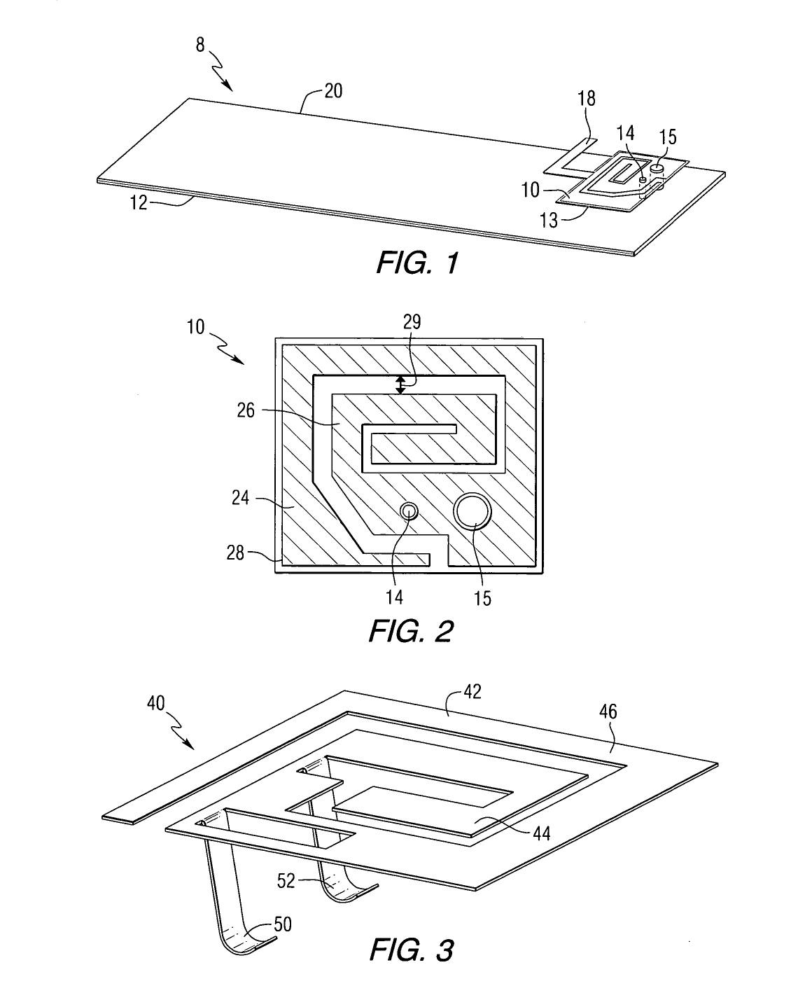

Although the antenna 88 is illustrated as comprising a relatively planar structure, such as the antenna 10 of FIGS. 1 and 2 or the antenna 40 of FIG. 3, the teachings of the invention are not so limited and can be applied to various antenna types to limit the user's SAR exposure as further described below.

The antenna 88 as illustrated in FIG. 5 comprises a radiating element 94 and physical and/or electrical connecting elements 96 attaching the radiating element 94 to the printed circuit board 90, specifically to the electrical components and conductive traces mounted thereon and to the ground plane 91 formed therein. The radiating element 94 operates in conjunction with the ground plane 91 as in the exemplary antennas described above, causing the antenna 88 to emit radio frequency energy when the handset 80 is operative in a transmitting mode and to receive radio frequency energy when the handset 80 is operative in a receiving mode. The antenna 88 as illustrated herein is intended to include any of the various antenna designs embedded in the handset 80, including those described above and others known in the art.

A specific absorption rate (SAR) in milliwatts/gram is a quantitative measure of the amount of radio frequency power absorbed in a unit mass of body tissue over a given time. In the interest of ensuring public and user safety, the Federal Communications Commission and other regulatory agencies have developed SAR limits for cellular telephone handsets. It is believed that handsets operating within the SAR limit will not produce harmful heating effects in the brain tissue of the user. All cellular handsets manufactured after Aug. 1, 1996 must be tested for compliance with the FCC imposed limits. By way of example, in Australia, the United States and Canada the SAR limit is 1.6 milliwatts per gram.

FIG. 6 generally illustrates a near-field radiation pattern 100 of the embedded antenna 88 when designed to operate in the PCS (Personal Communications System) band of 1850 to 1990 MHz in conjunction with the ground plane 91 on the printed circuit board 90. Based on a typical handset size, the printed circuit board 90 is about two inches wide and thus the ground plane 91 disposed thereon is also about two inches wide. For frequencies in the PCS frequency band, two inches represents about a half wavelength. Since half-wavelength structures act as reflective elements for impinging radio frequency waves, most of the energy directed toward the user 84 from the antenna 88 is reflected away from the user by the ground plane 91 carried on the printed circuit board 90. Thus the radiation pattern 100 is shaped generally as shown.

AMPS and CDMA cellular telephone systems operate in a frequency band of 824 to 894 MHz, with corresponding wavelengths of between about 14.2 inches and 13.0 inches. For this signal wavelength the ground plane 91 (being about two inches wide) on the printed circuit board 90 does not provide the advantageous reflective properties observed in the PCS frequency band. A resulting near field radiation pattern 102 is illustrated in FIG. 7, indicating substantially omnidirectional radiation, which may cause the SAR limit to be exceeded within the tissue of the user 84. Cellular phones or other handset devices operating with embedded antennas under the GSM standard in the 880 to 960 MHz band will also create radiation patterns similar to the pattern 102.

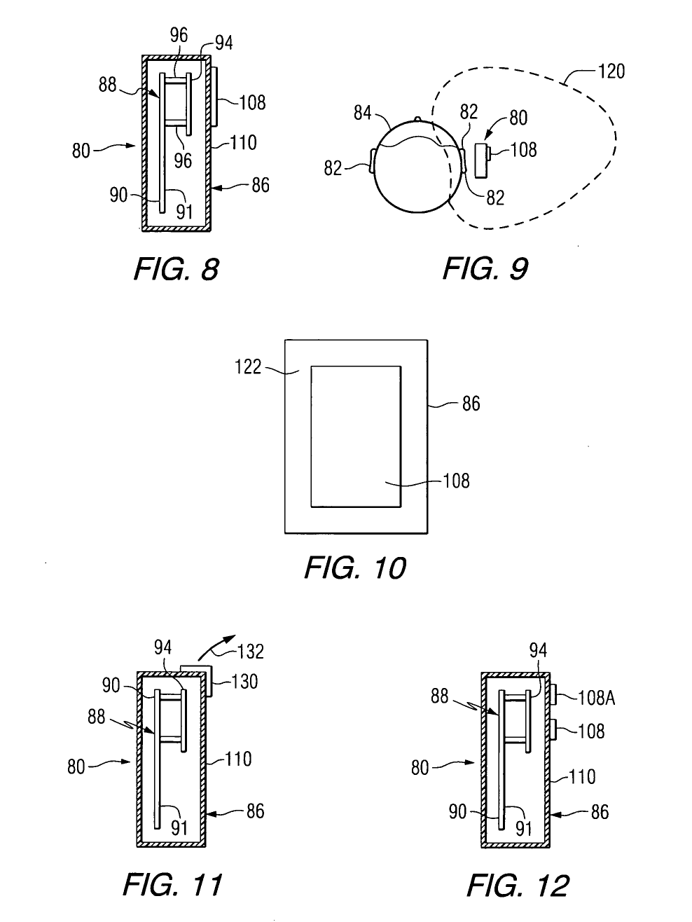

According to the teachings of the present invention, a conductive element 108 (See FIG. 8) is disposed proximate the radiating element 94. In one embodiment the conductive element 108 comprises a conductive strip or plate (in one embodiment comprising a copper strip or plate) affixed to an exterior surface 110 of the handset case 86 as illustrated. In one embodiment the conductive element 108 further comprises an adhesive surface for convenient attachment to a surface of the handset case 86. Thus this embodiment can be made available to owners of handsets 80 for convenient attachment to the handset case 86. In one embodiment a distance of about 0.1 to 0.2 inches separates the radiating element 94 and the conductive element 108. Depending on the electrical and mechanical properties of the radiating element 94 and the conductive element 108, other separation distances will also produce the desired effects. The separation distance is also influenced by the size of the handset case 86. In one embodiment a distance less than about 0.125λ is preferred.

Radio frequency energy emitted by the radiating element 94 of the antenna 88 induces current in the conductive element 108 resulting in a larger current distribution in a direction away from the user 84, that in turn produces greater near field energy in the same direction, i.e., away from the user 84. Since the antenna 88 can produce only a finite amount of energy, increased energy in the direction away from the user 84 reduces emitted energy in a direction toward the user 84. Use of the conductive element 108 has been shown to increase the energy emitted in a direction away from the 84 by about 0.25 to 0.50 dB and to decrease the energy emitted in a direction toward the user 84 by a similar amount. Thus the conductive element 108 produces a corresponding reduction in the SAR value to which the user 84 is exposed. An exemplary near field radiation pattern 120 resulting from use of the conductive element 108 is illustrated in FIG. 9.

Generally, the conductive element 108 has a length less than the effective electrical length of the radiating element 94 so as to direct energy away from the user. In an embodiment where the radiating element 94 operates as a half wavelength antenna, the length of the conductive element 108 can be less than about half a wavelength at the operating frequency (or operating frequency band). In one embodiment the conductive element length is about 0.1λ to 0.125λ. The conductive element 108 can be considered an energy director relative to the energy emitted by the radiating element 94.

Although illustrated for use in conjunction with the radiating element 94 and the ground plane 91, the conductive element 108 is not restricted to radiating elements operative with ground planes. Thus various antenna configurations can benefit from the teachings of the present invention.

In another embodiment illustrated in FIG. 10, the conductive element 108 is disposed on an inside surface 122 of the handset case 86. For example, the conductive element 108 can be affixed to an inside surface of the case during manufacture of the handset 88. An adhesive (including an adhesive backing material affixed to the element 108) can be employed to attach conductive element 108 to the case 86. Other known attachment methods, including bonding with a suitable adhesive, can also be employed.

In another embodiment a region of conductive ink can be printed on the handset case 86 (either on an interior or exterior surface of the case 86) to achieve the advantages taught by the present invention.

To optimize the results achieved by the teachings of the present invention, the conductive element 108 should be sized and positioned based on the physical and operating characteristics of the embedded antenna 88, as some degradation in performance parameters may otherwise result. Generally, the size and location of the conductive element 108 that produces the maximum SAR reduction can be determined experientially by varying the size and location of the conductive element 108 to obtain the maximum SAR reduction for a particular handset 80.

In other embodiments, the conductive element 108 can be positioned relative to the radiating element 94 to increase the radiated energy in a direction other than a direction away from the user 84. FIG. 11 illustrates a conductive element 130 positioned on the exterior surface 110 of the case 86 to increase the radiated energy in a general direction depicted by an arrowhead 132. In another embodiment the conductive element 130 can be positioned on a interior surface of the case 86. In yet another embodiment the conductive element 130 can be positioned in an interior region of the case 86, with appropriate support structures suitably positioned to properly locate the conductive element 108 relative to the radiating element 94.

In yet another embodiment, a plurality of conductive elements 108 and 108A can be positioned relative to the radiating element 94 to focus or direct the near field energy as desired, as illustrated in FIG. 12.

An antenna architecture has been described as useful for reducing a user's SAR exposure. While specific applications and examples of the invention have been illustrated and discussed, the principals disclosed herein provide a basis for practicing the invention in a variety of ways and in a variety of antenna configurations. Numerous variations are possible within the scope of the invention. The invention is limited only by the claims that follow.

1. A communications device operative in proximate relation to a user to transmit and receive radio frequency signals, the communications device comprising:
a radio frequency signal radiating element;
a ground plane spaced apart from and operative in conjunction with the radiating element;
a conductive element disposed proximate the radiating element for reducing the energy emitted in a direction toward the user.

2. The communications device of claim 1 wherein the conductive element reduces the specific absorption ratio exposure of the user.

3. The communications device of claim 1 further comprising a printed circuit board carrying at least a portion of the ground plane.

4. The communications device of claim 1 further comprising a case enclosing the radiating element and the ground plane wherein the conductive element is disposed on one of an interior surface and an exterior surface of the case.

5. The communications device of claim 4 wherein the conductive element comprises a conductive material and an adhesive material disposed thereon, and wherein the conductive element is fixedly attached to one of the interior surface and the exterior surface by affixing the adhesive material thereto.

6. The communications device of claim 1 wherein a material of the conductive element is selected from between conductive ink and a conductive metal.

7. The communications device of claim 6 further comprising a case for enclosing the radiating element and the ground plane, wherein the conductive ink is applied to an interior surface of the case.

8. The communications device of claim 1 wherein the conductive element is disposed in a direction away from the ground plane.

9. The communications device of claim 1 wherein the conductive element operates as a director of the radio frequency signal.

10. The communications device of claim 1 wherein a distance between the radiating element and the conductive element is about 0.2 inches.

11. The communications device of claim 1 wherein a length of the conducting element is between about 0.1λ to 0.125λ, wherein λ is a wavelength of the radio frequency signal.

12. The communications device of claim 1 wherein the conductive element is disposed, relative to the user, in a direction away from the radiating element.

13. A communications device operative in proximate relation to a user to transmit radio frequency signals, the communications device comprising:
a radio frequency signal radiating element;
a conductive element disposed proximate the radiating element for directing a portion of the radio frequency signal in a direction away the user.

14. The communications device of claim 13 wherein the radiating element is disposed between the user and the conductive element.

15. The communications device of claim 13 wherein the specific absorption ratio to which the user is exposed is reduced in response to the portion of the radio frequency energy directed away from the user.

16. The communications device of claim 13 wherein at least one of a size and a location of the conductive element are determined in response to a frequency of the radio frequency signal.

17. The communications device of claim 13 wherein a location of the conductive element is determined in response to a geometry of the radiating element.

18. The communications device of claim 13 wherein a location of the conductive element is determined in response to the proximate relation between the user and the communications device.

19. The communications device of claim 13 wherein during use the communications device is held near the user's ear, and wherein the conductive element reduces the radio frequency energy absorbed by body tissue proximate the ear when compared with the radio frequency energy absorbed by the body tissue in the absence of the conductive element.

20. The communications device of claim 13 wherein the radio frequency energy induces current in the conductive element producing an increased current distribution in a direction away from the user.

21. The communications device of claim 20 wherein the increased current distribution increases the near field energy in a direction away from the user and reduces the near field energy in a direction toward the user.
